(19) United States
(12) Patent Application Publication
(10) Pub. No.: US 2011/0274455 A1
(43) Pub. Date: Nov. 10, 2011

(54) TONER STARVATION REDUCTION USING PATCH SENSING AND FEEDBACK

(75) Inventors: Rodolfo E. Valladares, Rochester, NY (US); Rasin Moser, East Rochester, NY (US)

(73) Assignee: XEROX CORPORATION, Norwalk, CT (US)

(21) Appl. No.: 12/774,747

(22) Filed: May 6, 2010

(51) Int. Cl. G03G 15/00

(52) U.S. Cl. 399/49

(57) ABSTRACT

The present disclosure is a simple method to compensate for development starvation in an existing development control system already using solid area development and halftone development patches. By using a small aperture specular sensor, it is possible to measure the starvation and compare with a standard. Defect level can then be addressed by correcting toner concentration to reduce the image density defect at the solid/halftone boundary.

### BACKGROUND

1. Field of the Technology

The present disclosure relates to systems and methods for reducing print defects in electrostatically formed images.

2. Description of the Prior Art

The electrophotographic printing process is well known. Typically, electrostatic imaging and printing processes include several distinct stages. These stages typically include some or all of (1) charging, (2) exposing, (3) developing, (4) transferring, (5) fusing, and (6) cleaning. An electrophotographic printing system typically includes a printer or a marking engine. The printer or marking engine may include a photoconductive belt or drum as a photoconductive surface.

In the charging stage, a uniform electrical charge is uniformly deposited on the surface of the photoconductive belt or drum to electrostatically sensitize the photoconductive surface. The electrophotographic exposing stage includes rotating or moving the charged photoconductive surface to an exposure station, where the charged portion of the photoconductive surface is exposed to light from, for example, a scanning laser beam. By modulating the light beam, an electrostatic latent image of variable electrostatic potential is recorded on the photoconductive surface. The light beam is modulated with an input serial stream so that individual picture elements or pixels of the image represented by the data stream are exposed on the photoreceptor to form the latent image.

The electrophotographic developing stage uses a developer material, such as a toner powder, which is attracted to the latent image in varying densities depending varying electrostatic potential of the latent image. In the transferring and fusing stages, the toner powder image is transferred to a copy sheet, and finally the toner powder image is heated and/or pressed to permanently fuse the powder image to the copy sheet in the image configuration. In the electrophotographic cleaning stage, the photoconductive surface of toner is cleaned and the charge images are discharged so that the process can be reliably repeated.

It is well known in the prior art of process control to schedule solid area, uniform halftones or background in a test patch. Some printers contain many test patches. During the print run, each test patch may be scheduled to have single halftone that would represent a single byte value on the tone reproduction curve. This is a complicated way to increase the data bandwidth required for the process control loops. It also consumes customer toner for printing many test patches. For example, U.S. Pat. No. 5,060,013 discloses a control system using test patches at different locations within the image frame on the photoreceptor. A plurality of sensors are arranged to sample the test areas in defined columns of the frame and measurements coordinated with the location of the test area.

It is also known in the prior art, for example, U.S. Pat. No. 4,341,461 to provide two test targets, each having two test patches, selectively exposed to provide test data in the photoreceptor image area for control of the toner dispensing and bias control loops. In this system, the test patches are imaged in interdocument zones on the photoreceptor. In addition, U.S. Pat. No. 5,450,165 discloses the use of incoming data or customer image data as a test patch. In particular, incoming data is polled for preselected density conditions to be used for test patches to monitor print quality.

Defects in the scanning and printing process can arise from one or more of the stages described above. Defects may occur in the development stage, where parts of the processed image will have regions of diminished toner density. Such regions of diminished intensity tend to occur in electrostatic printing at an interface of two objects of an image having different gray levels, and therefore different electrostatic potential and toner densities. The object that would result in a higher toner density can “steal” toner from the region that would result in a lower toner density, creating a toner “starvation” or “white space” defect.

It is also known, as disclosed in U.S. Pat. No. 7,295,349 that, as the electrostatic latent image passes serially through the development process, some images may contain features that have a darker solid region on top of a lighter solid region. The lead edge of the dark solid is the edge that passes first through the development stage. The trail edge of a dark solid is the edge that passes last through the development state. In this process, the white space can occur either on the lead edge of the interface, the trail edge of the interface, or both, and that the magnitude of the white space can be different. U.S. Pat. No. 7,295,349 discloses methods that compensate for the white space defect by modifying the input image pixel intensity and/or the input image bitmap. The input image intensity values in lighter regions that precede or occur near a light-to-dark transition to a dark object are raised above the input image intensity values. Thus, when printed, the printed image intensity values in such regions are higher than the corresponding image intensity values.

### SUMMARY OF DISCLOSURE

The present disclosure is a simple method to compensate for degradation of developed images at the borders of halftone and solid areas, known as the starvation effect. The starvation effect is the scavenging by the developer brush of toner from a previously developed portion of a half tone area. The method is applicable in existing development control systems already using solid area and halftone patches, by using a starvation test patch and a small aperture specular sensor. However, it should be understood that the disclosure is not limited to existing control schemes and would apply to other development control systems where toner depletion at the boundary of dissimilar image portions was an issue.

Various of the above-mentioned and further features and advantages will be apparent to those skilled in the art from the specific apparatus and its operation or methods described in the example below, and in the claims. Thus, there will be a better understanding from this description of specific embodiments, including the drawing figures, wherein:

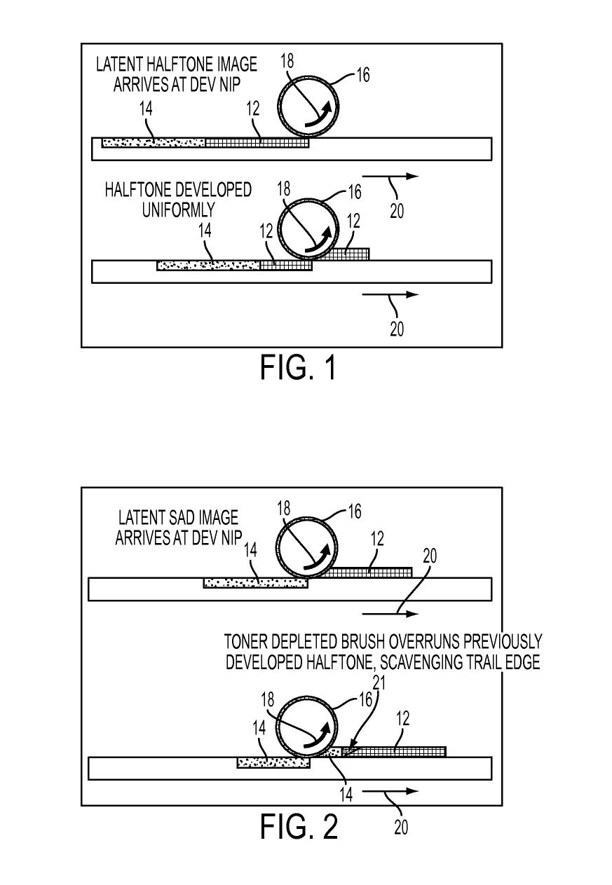

FIG. 1 illustrates a uniform development of an image halftone;

FIG. 2 illustrates a scavenged image half tone; and

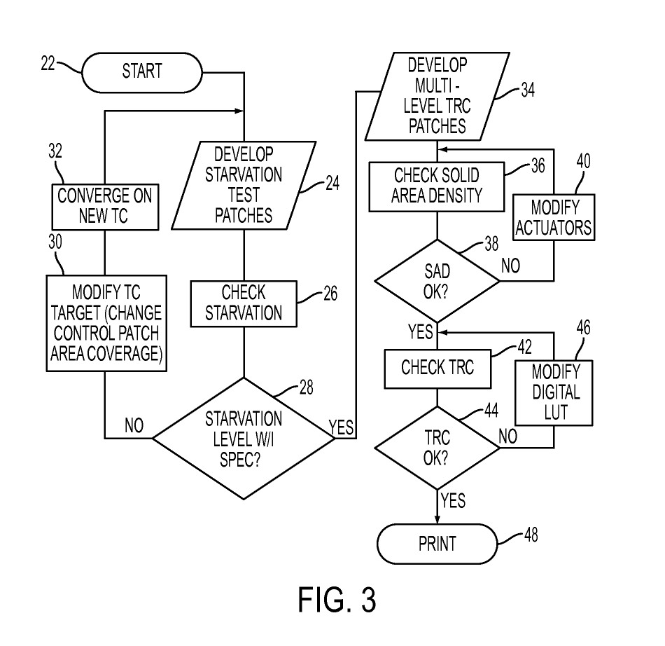

FIG. 3 represents a flow chart of a control for preventing toner scavenging according to the present disclosure.

### DETAILED DESCRIPTION OF DISCLOSURE

In such electrophotographic printing, the step of conveying toner to the latent image on the photoreceptor is known as “development.” The object of effective development of a latent image on the photoreceptor is to convey toner particles to the latent image in a controlled manner so that the toner particles effectively adhere electrostatically to the charged areas on the latent image.

When the developer material is placed in a magnetic field, the carrier beads with toner particles thereon form what is known as a magnetic brush, wherein the carrier beads form relatively long chains which resemble the fibers of a brush. This magnetic brush is typically created by means of a “developer roll.” The developer roll is usually in the form of a cylindrical sleeve rotating around a fixed assembly of permanent magnets. The carrier beads form chains extending from the surface of the developer roll, and the toner particles are electrostatically attracted to the chains of carrier beads.

When the magnetic brush is introduced into a development zone adjacent to the electrostatic latent image on the photoreceptor, the electrostatic charge on the photoreceptor will cause the toner particles to be pulled off the carrier beads and onto the photoreceptor.

Typically, solid area development control is established by creating toner control patches of single desired density. Control patches are created using the primary scanning laser beam or an alternate light source, such as a patch generator, to discharge the photoreceptor to the proper development field. The actual developed mass per unit area (DMA) of the toner on the control patches is then optically measured to determine the effectiveness of the printing process in placing the toner on the print sheet. Typically, a specular reflectance sensor is used for determining the density of the toner on a control patch. Both solid area and halftoned control patches of varying densities, including a black solid area control patch, can be used to assure color quality control. Solid patches are represented on a Solid Area Developability Curve and halftoned patches are represented on a Tone Reproduction Curve (TRC).

With reference to FIG. 1, there is illustrated a latent halftone image area arriving at a developer nip in the direction of arrow 20, ahead of a latent solid toner image area as shown in the top view of FIG. 1. In particular, the halftone area 12 precedes the solid area 14 to a developer nip as shown by a developer brush 16, rotating in the direction of the arrow 18 and carrying (not shown) toner particles to be applied to the different portions of an image. As illustrated in the top view, the halftone area 12 has just arrived at the brush 16.

As pixels of the latent halftone image area 12 advance past the brush 16, as shown in the bottom view of FIG. 1, there is illustrated uniformity of the development of the halftone area 12 by the brush. The uniformity of the development of the halftone area 12 continues and there is no disturbance of the toner representing the halftone area 12, at least not until the development of the latent solid area 14 begins.

However, with reference to FIG. 2, there is illustrated, in the top view, the latent solid area image area 14 arriving at the developer nip shown by the developer brush 16, following the halftone image area 12. At this point, a disturbance in the development of the preceding halftone image area 12 often occurs. It is known as halftone degradation caused by a toner depleted brush scavenging the halftone toner as the halftone image 12 exits the development nip.

This is illustrated in the bottom view of FIG. 2. In particular, the toner depleted brush 16 overruns the end of the previously developed halftone image area 12, scavenging the trail edge of the halftone image area as shown at 21. This is often referred to as a starvation defect and results in a degradation of image quality at the borders of halftone and solid area images.

With reference to FIG. 3, a flow diagram represents a control method for preventing toner scavenging as shown in FIG. 2, according to the present disclosure.

In particular, the control procedure is activated as shown at 22 and the first step is to develop starvation test patches as illustrated at block 24. The charge on the photoreceptor for the test patches and the location of the patches on the photoreceptor is a selected design parameter for a particular control. At block 26, a small aperture sensor reads the developed image at a solid area/halftone boundary and, as illustrated at block 28, the sensor signal representing the developed boundary is compared to a standard test patch.

The degree of difference between test development and actual development is determined. If actual development is not within specification, there will be a modification of the toner concentration target as shown in block 30. The modification of the toner concentration target generates a change in suitable developer components to increase or decrease the amount or level of toner in the developer, as illustrated at block 32. In particular, if there is unacceptable scavenging of toner from a portion of the halftone area, the toner concentration level in the developer will be lowered.

If the starvation level is determined at block 28 to be within specification, then the next step in the control is to develop multilevel Tone Reproduction Curve patches as shown in block 34. First the solid area density of the developed image is sensed as illustrated at block 36. This measurement is then checked or compared with the test or standard patches to determine whether or not the solid area development of the system meets specification, as shown in block 38. If not in specification, actuators for providing solid area toner coverage are adjusted to provide appropriate solid coverage as shown in block 40.

If the solid area coverage of the measured developed image is within specification, the next step is then to check the overall developed halftone coverage, the tone reproduction curves (TRC), as illustrated at 42. This sensed degree of development is compared to the multilevel TRC patches to determine if the halftone development is within specification. If not, there is a modification of the tone reproduction curve Look Up Table (LUT) as shown in block 46. If within specification, the final step is to print the developed image shown at 48.

It should be apparent, therefore, that while specific embodiments of the present disclosure have been illustrated and described, it will be understood by those having ordinary skill in the art to which this invention pertains, that changes can be made to those embodiments without departing from the spirit and scope of the disclosure. Further, the claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What we claim is:

1. A method for reducing image starvation defects in a xerographic printer having a developer, the method comprising:
providing a toner concentration sensor to provide a standard toner concentration target for applying toner to a photosensitive surface,
generating a starvation defect test patch to provide a quality standard, the quality standard being a measure of acceptable starvation defects in a printed image,
comparing developed images of the photosensitive surface to the quality standard of the starvation defect test patch, and
responding to a starvation defect deviating from the quality standard of the starvation defect test patch to modify the standard toner concentration target.

2. The method of claim 1 wherein the step of responding to a starvation defect includes the step of adjusting the starvation defect test patch.

3. The method of claim 1 including the step of lowering the standard toner concentration target of the developer for applying toner to the photosensitive surface.

4. An electronic printing system for providing halftone image pixels and solid area image pixels comprising:
a developer for providing toner particles to the halftone and solid area image pixels,
a medium for receiving the halftone image pixels and the solid area image pixels, the medium positioned to receive the toner particles from the developer,
a toner concentration control, the toner concentration control providing the image density for the halftone and solid area image pixels of the printing system,
a sensor to detect image defects at the boundaries of halftone image pixels and solid area image pixels, and
an image defect control to monitor the sensor and respond to the image defects at the boundaries of halftone image pixels and solid area image pixels by adjusting the target toner concentration.

5. The printing system of claim 4 wherein the sensor is a small aperture, specular reflectance sensor.

6. The printing system of claim 4 including an image defect test patch and wherein the control compares signals from the sensor with signals from the test patch to determine toner defects.

7. The printing system of claim 6 wherein the image defect test patch is adjusted in response to the signals from the sensor.

8. The printing system of claim 6 including a toner concentration sensor and wherein the toner concentration control modifies the toner concentration in response to the signals from the sensor to detect toner defects.

9. A xerographic printer for adjusting preselected solid area development and halftone development targets to maintain toner concentration uniformity at the boundaries of solid areas and halftones, the xerographic printer including:
a moving photoreceptor,
means for charging the photoreceptor,
a projection system for projecting an image having solid area and halftone boundaries onto the photoreceptor,
a means for generating test patches to maintain tone reproduction curves and solid area development,
a sensor for determining the image density at the boundaries of halftone and solid area development, and
a toner concentration control for responding to the sensor to adjust image density defect at the boundaries.

10. The printer of claim 9 including means for generating a test patch providing a target toner concentration at the boundaries of halftone and solid area development.

11. The printer of claim 9 wherein the toner concentration control includes the means to reduce image density defect at the boundaries of halftone and solid area development.

12. A method for reducing image defects at the boundary of halftones and solid areas in a xerographic printer having a photosensitive surface receiving images and a developer providing toner to images comprising the steps of:
providing a developed image standard for application of toner to a boundary between halftones and solid areas,
comparing developed images at the boundary of halftones and solid areas to the developed image standard, and
responding to the comparison to modify the toner concentration and the image density defect level at the boundary of halftones and solid areas.

13. The method of claim 12 including the step of providing a boundary test patch to set a boundary developed image density test standard.

14. The method of claim 12 including the step of providing a toner concentration test patch to provide a standard toner concentration target for applying toner to the photosensitive surface.

15. The method of claim 13 including the step of adjusting the toner concentration to improve the boundary developed image density compared to the boundary developed image density test standard.

16. The method of claim 13 including the step of decreasing the toner concentration at the boundary of the halftones and solid areas.
